(19) United States
(12) Patent Application Publication
(10) Pub. No.: US 2002/0176018 A1
(43) Pub. Date: Nov. 28, 2002

(54) Variable message format transmission protocol, enabled on cable television networks as a bypass of physical local telephone exchange carrier networks for long distance telecommunications services

(76) Inventors: David Edward White, Boca Raton, FL (US); Herbert Frank Primosch, Incline Village, NV (US); Joseph Leonard Fattizzi, Woodway, WA (US); Gregory Socrates Rahman, Huntington Station, NY (US)

Correspondence Address: David White, 4038 Newcastle B, Boca Raton, FL, 33434, US

(21) Appl. No.: 09/850,550

(22) Filed: May 25, 2001

(51) Int. Cl. H04N 7/173; H04N 5/225

(52) U.S. Cl. 348/359

(57) ABSTRACT

A method for the deployment of long distance telecommunications services over existing cable television operator networks. Provides bypass of long distance telecommunications services directly from residential and commercial customers utilizing a bypass specific device. This device will route long distance communications, in a specific format defined in this application, to a cable operator network. Local telecommunications service are placed directly to the existing local exchange operator network. Digital information traffic directed from residential and commercial customers are directed to and managed by a specific device located in a cable television operators central office. This device is specifically tuned for digital information traffic defined in this application.

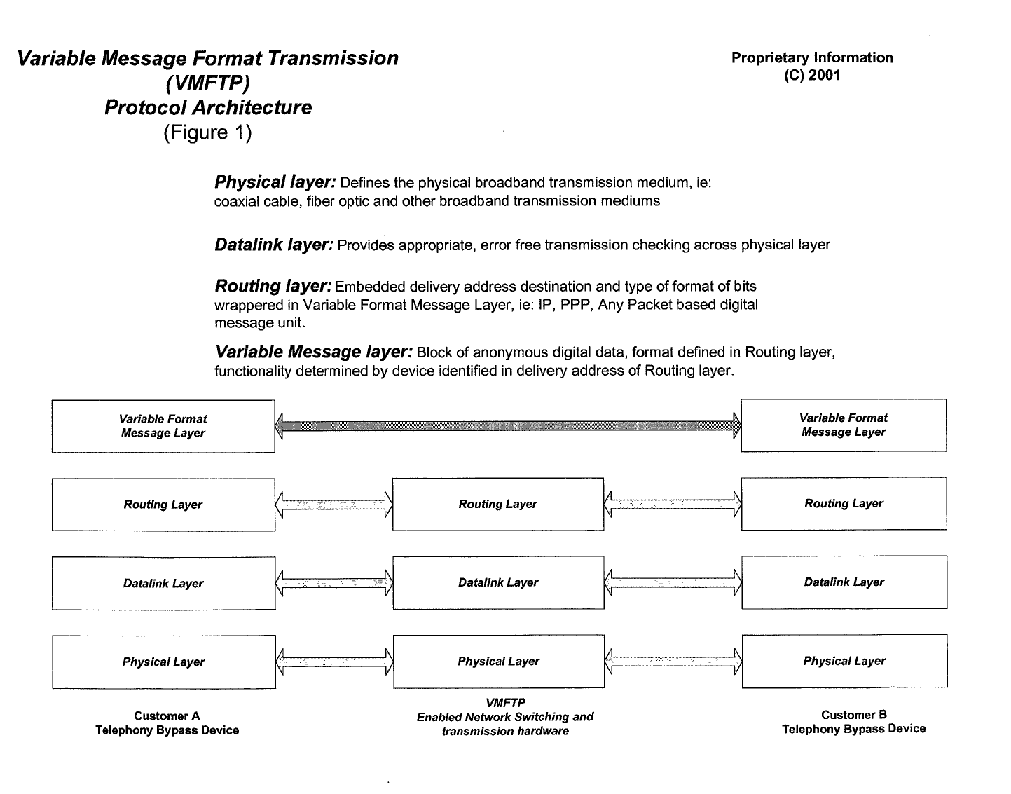

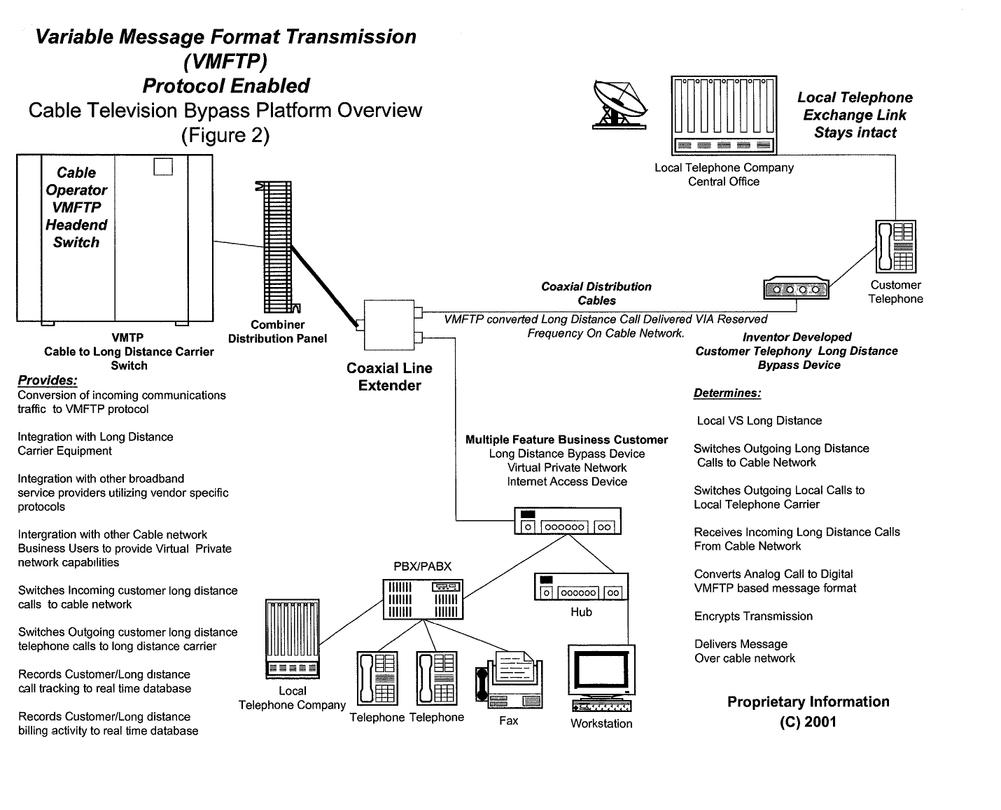

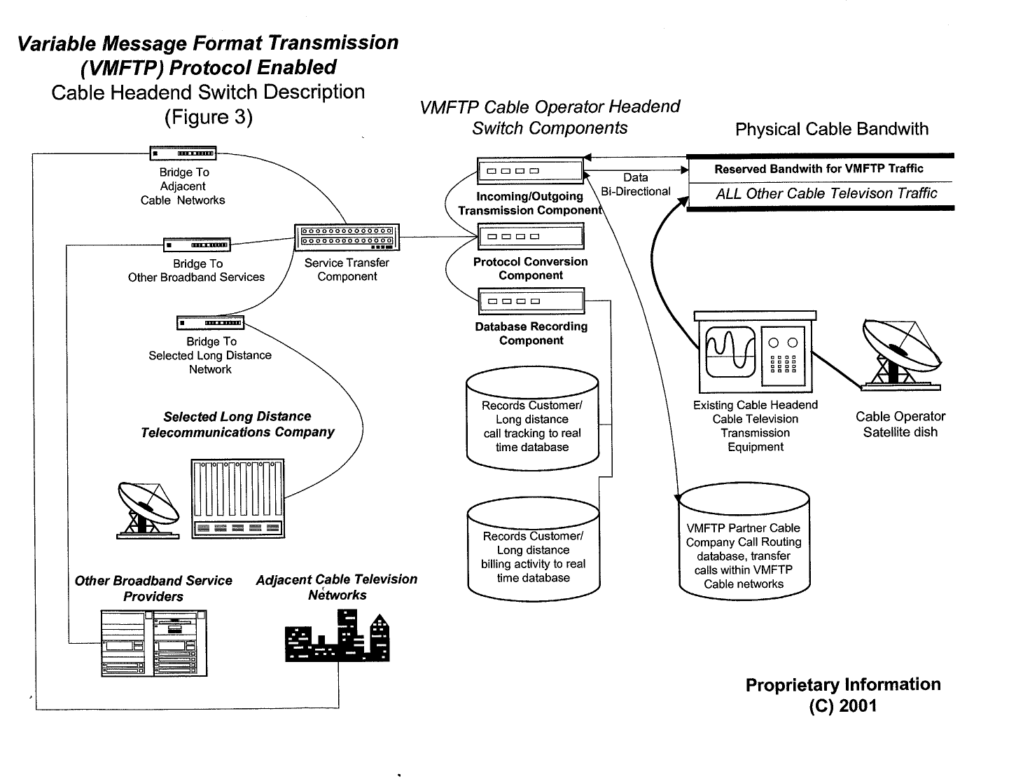

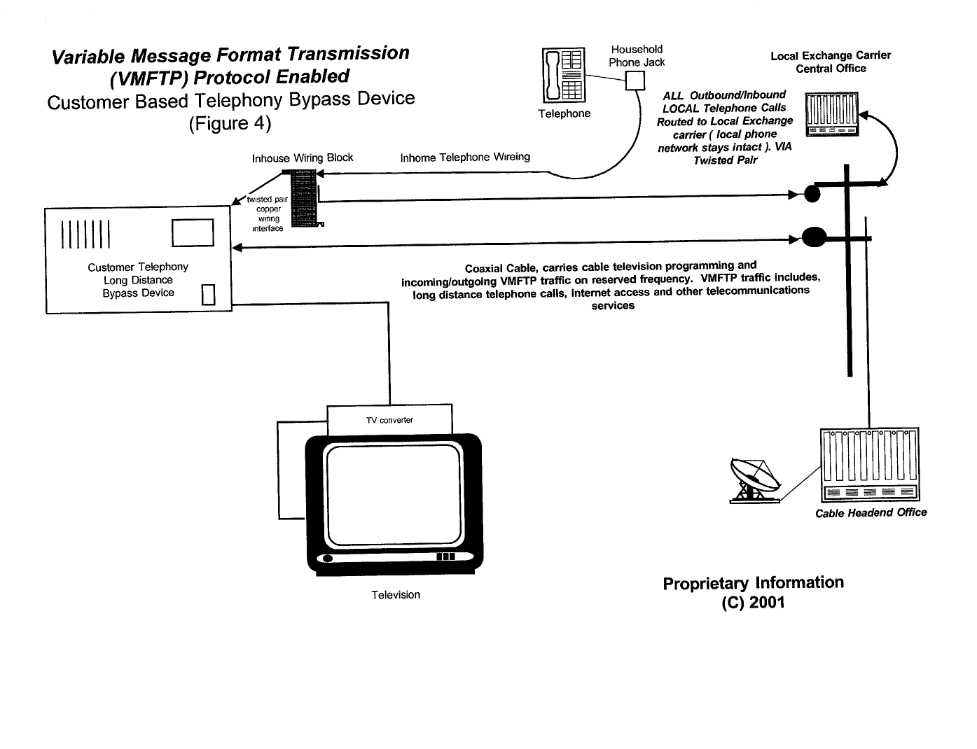

### BACKGROUND

Description of Prior Art

a) Telecommunications equipment manufacturers have developed various telephony equipment to allow cable operators the ability to provide telephony services to residential and commercial customers within the cable system. Although the design may vary among the various models, the fundamental operation of all telephony equipment, built by these manufacturers in the provision of telecommunications services over a cable television network remains the same. Specifically, to replace the current local exchange carrier with the cable operator in the provision of all telecommunication services handled by the local exchange carrier network including local telephone service, long distance calls, data, Internet access, as well as any and all services that required local exchange carrier participation; in effect, the local carrier will cease to exist from a residential or commercial customer standpoint. The cable operator would then become the exclusive provider of all telecommunications services which previously had been the responsibility of the local exchange carrier.

b) There are many flaws with this concept, the primary being a total lack of incentives for residential or commercial users to accept such systems. In order for users to accept these systems they had to be willing to replace current telephone numbers with new numbers, as current telephone numbers belonged to the local exchange carriers, not the cable operators. Lose all telephone service in the event of a cable television outage, since all services would be provided over the cable television line. Pay for the telephony equipment and accompanying installation with no economic incentive to do so. Although replaced in the home or business, the local exchange carrier network is still an essential requirement for cable telephony as all calls placed on a cable system require transfer to other networks. Cable systems by nature are independent of each other, as connectivity between them is not necessary for the provision of cable television services, though connectivity for local telephone, long distance and other communication services is essential. The local exchange carrier is still required to provide this connectivity. With dependence on its competitor, cable operators are unable to undercut fees associated with the placement and completion of calls and other communication services, thus providing no economic incentive for users to accept it.

c) These telephony systems are passive devices, providing only a connection to the cable distribution system. There are no system specifications to allow for provision of certain telecommunication services and not others. All telecommunication services must be provided or none at all creating a “take it or leave it” attitude with potential users. Users never accepted these systems simply because there are no benefits in doing so.

d) Cable operators, hoping to create new markets and revenue streams have been unable to do so through the massive rejection by end users of telephony options currently available. In addition, cable operators have lost billions of dollars in capital expenditures by upgrading distribution networks to accommodate telephony systems, which required these upgrades in order to operate. One such requirement is a power source. Telephony equipment is usually installed on the side of the house or business with the connection made to the cable television distribution network from a cable coming off the telephone pole or other link to the network. Power is supplied through the cable system, which ultimately powers the telephony device. The flaw in this type of operation is the power source. The original design of the cable distribution network prevented voltage from going to the home. The ports on the “tap” a device which provides the direct connection to the cable television network does not pass power on the port side, thus preventing voltage from going to the home which of course could damage equipment designed to accommodate only RF.

In order to make telephony equipment work, current taps had to be replaced with those that would pass power to the telephony device to make it operational. This created a new set of problems, as the voltage, provided to run line extenders in the cable distribution network, which remained consistent, had to become variable to support telephony equipment.

e) Cable television operators are essentially sub-contractors. They build a network in an area, which is “franchised” to them by the municipality, allowing them to cross county owned roads. These franchises are usually exclusive, with one cable operator to a franchised area. Once a cable operator builds a cable television network in the franchised area, it is his job to market the cable television programming to the local residents. All equipment and materials needed to build the cable television network and provide cable television services are bought from equipment manufacturers, cable manufacturers and suppliers. Telephony equipment is bought in the same manner, except that capital costs are not recouped as revenue cannot be generated from the equipment purchased.

### SUMMARY

In accordance with the present invention, the system will bypass the local exchange carrier in the placement and completion of long distance calls, data and the provision of Internet access and other telecommunication services.

### OBJECTS AND ADVANTAGES

Accordingly, besides the objectives and advantages of the VMFTP enabled cable television network bypass system, described in the above patent, several objectives and advantages of the present invention are:

(a) The local exchange carrier remains intact and continues to provide dial tone, local telephone services and operator assistance.

(b) By keeping the local exchange carrier intact, existing telephone numbers remain.

(c) The system operates seamlessly to bypass the local exchange carrier network in the provision of long distance calls, data and all other telecommunication services.

(d) No specific upgrades to the cable television distribution network are required to support operation of the system beyond being two-way in nature.

(e) The system can utilize the vertical interval or appropriate unused bandwidth to accommodate transmission of services.

(f) Telephone services remain intact in the event of interruption of cable television services due to distribution failure as the system defaults all telecommunication services back to the local exchange carrier.

(e) A special switch at the cable television head end will recognize all address-encapsulated telecommunication services bypassed to the cable television distribution network. Once recognized, the encapsulated address is forwarded to an interexchanage carrier network.

(f) The interexchange carrier network is provided continuously updated information from a system database at the cable television head end on each and every address encapsulated data pack.

(g) The VMFTP enabled cable television network bypass system will operate on all two-way cable systems whether they are digital or analog.

(h) A special program will be installed at the interexchange database to recognize all incoming address encapsulated telecommunications transmissions from the cable television head end.

(i) The system, on the completion side of the transmission, will act passively on all incoming telecommunication services received by the end user.

(j) The system will not interfere with cable television operation or local exchange services operation in any way aside from the obvious bypass of the local exchange carrier.

(k) The system will operate on all cable distribution formats consisting of coaxial, fiber optic and hybrid networks.

(l) The bypass of the local exchange carrier is performed by transferring only long distance calls, data and other telecommunication services instantly upon the placement of such services from the home or business. This is accomplished as follows: When the user dials 1, the area code and telephone number, the system, by virtue of a device installed in the home in the proximity of the Telco interface, and the point where the cable television line enters the home. The system device is physically connected in the home with both the Telco interface and the cable television line.

All long distance calls, data or any other telecommunication service desired are instantly transferred to the cable television distribution network upon initial placement of 1, area code and telephone number. The local telephone carrier stays intact and provides dial tone, local telephone service and all operator assisted functions. Immediately prior to transfer, an address is encapsulated with the long distance call, data or other communication service. Once transferred over to the cable television distribution network, the long distance call, data or other communication services are sent back on the cable television distribution network to a special switch at the cable head end. The switch is programmed to recognize the address, which then routes the long distance telephone call, data or other communication service to an interexchange carrier network. A database at the cable television head end keeps a record of all user address encapsulated information A dedicated link between the switch at the cable television head end and the interexchange network facility provides continuous updated information on all addresses encapsulated and sent to the interexchange network database. A switch at the interexchange carrier routes all encapsulated addresses for long distance calls, data and other communication services to participating cable television systems head ends. The long distance call, data or other communication services are then transmitted on the cable distribution network for completion. The device in the home or business which bypasses the local exchange carrier and is responsible for the placement of long distance calls, data or other information services, bypasses the incoming call or data and is either answered by the end user or received by a database.

(m) The system device in the home is continuously in contact with the database at the cable television head end to ensure optimum system performance and has self diagnostic capability.

(n) The system will keep an internal record of all information on every aspect of each bypass and transfer. This record is transferred to a database at the cable television head end every 24 hours.

(o) The VMFTP enabled cable television network bypass system will offer interexchange carrier networks an alternative to the local exchange carrier networks in the carry and transfer commonly known as “service access” or “switched access” in the transfer of long distance calls, data and other telecommunication services to interexchange carrier networks.

(p) The system will enable the placement, carry and transfer of international long distance calls on the placement side. Once transferred to the interexchange network, the international call is completed through foreign networks as usual.

(q) All telecommunications services shall be encrypted by the telephony device at the home or business upon transfer to the cable television distribution network. Encryption will remain in place throughout the entire transfer, placement and completion of the long distance call, data or other telecommunication services. Each telephony device in the home or business responsible for the bypass of the local exchange carrier for telecommunications services shall be “hard coded” as to function in only the original location it is installed for.

(r) The system will bypass both the local exchange carrier and the interexchange carrier for telecommunications services in circumstances where two or more participating cable television systems happen to border each other. Specifically, if two or more cable television distribution networks, are all using the system, then a bypass of both the local exchange carrier and the interexchange carrier networks will take place. Certain parameters must exist in order for both the local exchange carrier AND the interexchange carrier networks to be totally bypassed in the placement and completion of long distance calls, data, and other telecommunication services. Specifically, all cable distribution television networks bordering each other and located in the areas of the placement and completion of the long distance call, data or other telecommunication services must be using the system. Both end users on the placement and completion of the long distance call, data or telecommunication service must be using the system. In addition, upon the dialing of the telephone number, a 1 and the area code must precede the telephone number being dialed. Local calls that do not require an area code will remain on the local exchange carrier network. In situations where cable television networks border each other, though only the person on the placement side is using the system, the interexchange carrier is still bypassed, while the local exchange carrier is bypassed only on the placement side when the long distance telephone call, data or other telecommunication service is made. The local exchange carrier will complete the long distance call or other telecommunication service in this circumstance. Even if all parameters are met as stated, the end user will always keep, if in name only, their existing local exchange and interexchange network companies.

Conclusion, Ramification, and Scope

Accordingly, the reader will see that the system creates a viable telephony solution as the local exchange carrier is seamlessly bypassed for all long distance calls, data, Internet access and other telephony services. By doing so, a competitive environment will be realized as interexchange carriers will have an alternative to local exchange carriers in the carry and transfer of telecommunications services. This new found competitive environment would benefit end users as service access rates decline, ultimately providing a savings to users. In addition, cable operators will benefit, as the system will create a user-friendly telephony business with incentives to end users, without any flaws inherent in other systems.

The system will create an entirely new protocol as telecommunication services are carried on cable distribution networks. The new protocol, now known as a “Variable Message Format Transmission Protocol” will create a new venue for the carry and transfer of telecommunications on cable television distribution networks. These networks, with their broadband capabilities are an ideal venue for the carry and transfer of long distance calls, data, Internet access, money transfers and facsimiles. The inherent flaws in other telephony systems prevented cable television distribution networks from becoming a viable alternative to local exchange carrier networks. In addition, the independent nature of cable television distribution networks precluded a vital element: connectivity. The VMFTP enabled cable television network bypass system creates, for the first time, connectivity among independent cable systems by providing linkage between the cable television distribution network and interexchange carrier networks without local exchange network participation, yet keeps the local exchange carrier in place as the local telephone provider. This strategy and business model is essential to telephony success because the local exchange networks must remain in place as their networks and connectivity are established nationwide. The premise of bypassing only specific telecommunications services such as long distance calls and data allows for the elimination of local exchange networks in the placement, carry and completion of these services because the entire loop of placement and completion is accomplished with the cable television distribution networks in conjunction with interexchange carrier networks.

Local telephone services, however, must remain as the local exchange carrier, as only local exchange carrier networks have the massive connectivity to virtually every home and business, which independent cable television distribution networks do not. The VMFTP enabled cable television network bypass system creates the linkage through the integration of the cable television distribution networks and interexchange networks, but for only certain services such as long distance calls, data and other services, though not for local telephone service as it is very evident that the cable distribution networks do not have any where near the connectivity among homes and businesses that local exchange carrier networks possess. Therefore, the niche strategy incorporated by VMFTP creates linkage for telecommunication services except for that of local telephone service.

The new protocol, developed, instituted and established by VMFTP will have a vast impact on long distance telephone and data services as the current telecommunication environment will change as interexchange carrier networks will have an alternative, which they do not currently have now, to the local exchange carriers in the placement, transfer and completion of long distance calls, data and other telecommunication services.

We claim:

1. A method permitting the transmission of long distance telecommunications services directly from consumer and business entities over existing cable television broadband networks utilizing at least the Virtual Message Format transmission protocol in order to bypass local telecommunications exchange service providers for the placement and completion of long distance telephone calls.

2. This method includes the use of a customer and business deployed hardware device referred to as “Customer Telephony Long Distance Bypass Device”. This device will determine the destination of the outgoing telecommunications request and bypass that outgoing traffic to a long distance or other telecommunications service provider. When an outgoing service is determined to be long distance or other cable operator defined service, the device will convert and transmit this information in at least the Virtual Message Format Transmission Protocol.

3. This method provides but is not limited too, that all local telephone exchange call placement capabilities are kept in place. Services provided by local exchange carriers are kept in place with no modification to services provided by these organizations.

4. This method provides for local exchange carrier placement of long distance services if failure occurs on cable operator Virtual Message Format Transmission Protocol enabled network.

5. This method provides for the transmission of Virtual Message Format Transmission Protocol digital services over existing co-axial cable television wiring infrastructure but is not limited to this transmission medium.

6. The defined Virtual Message Format Transmission Protocol is suitable for all other transmission mediums.

7. The defined Virtual Message Format Transmission Protocol is suitable for all other transmission protocols since it acts as a wrapper of existing formats and is implemented and customized for individual cable television operators.

8. The method permits determination of information contained in a Virtual Message Format Transmission protocol digital data stream by the receiving end device. The routing layer of the Variable Message Format Transmission protocol is stripped from the data stream by a customer or cable operator deployed bypass device or other Virtual Message Format Transmission enabled devices.

9. This method when deployed by cable television operators at the operators transmission facilities will utilize a device defined as the Virtual Message Format Transmission Protocol Headend Switch.

10. The Virtual Message Format Headend switch will provide the actual transfer of at least consumer or business placed outgoing long distance telephone services to the appropriate long distance service provider.

11. The Virtual Message Format Headend switch will not be limited to long distance telecommunications services only.

12. The Virtual Message Format Headend switch will determine and reserve a specific bandwidth frequency range for Virtual Message Format Transmission protocol digital traffic.

13. The Virtual Message Format Headend switch and Customer Telephony bypass device, when used in unison, will permit bi-directional, both send and receive, digital communications.
